(19) United States
(12) Patent Application Publication
(10) Pub. No.: US 2020/0387960 A1
(43) Pub. Date: Dec. 10, 2020

(54) System and Method for Finding a Compatible Partner for a User

(71) Applicant: Jack MCKEOWN, SR., Cupertino, CA (US)

(72) Inventors: Jack McKeown, SR., Cupertino, CA (US); Jack McKeown, JR., Cupertino, CA (US)

(21) Appl. No.: 15/772,722

(22) PCT Filed: Dec. 22, 2017
(86) PCT No.: PCT/US17/68360

§ 371 Date: May 1, 2018

Related U.S. Application Data
(60) Provisional application No. 62/438,739, filed on Dec. 23, 2016.

(51) Int. Cl. G06Q 30/08; G06Q 50/00

(52) U.S. Cl. CPC G06Q 30/08; G06Q 50/01

(57) ABSTRACT

A computer-based method for finding a compatible partner for a user includes: determining one or more of a birth card (BC) of the user and a planetary ruling card (PRC) of the user; if a desired connection is a friendship connection or a romantic connection, representing one or more of the user's BC and the user's PRC as M_{i,j}, where i and j are indices of one or more of a spiritual spread of the user and a life spread of the user:

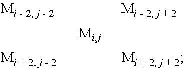

representing with blank cards birth cards that have diagonal element indices that fall outside a spread; removing the blank cards; using remaining elements, computing remaining compatible diagonal elements; and adding the compatible diagonal elements to the compatible cards array, so as to compute compatible diagonal elements for one or more of the user's BC and the user's PRC.

### PRIORITY CLAIM

The present application claims the priority benefit of U.S. provisional patent application No. 62/438,739 filed Dec. 23, 2016 and entitled “System and Method for Finding a Compatible Partner for a User,” the disclosure of which is incorporated herein by reference.

### SUMMARY

Embodiments of the invention relate in general to a system and method for finding a compatible partner for a user.

A computer-based method for finding a compatible partner for a user by computing compatible diagonal elements for the user's birth card includes: using one or more of a divination card system, a user's birthday and a standard deck of fifty-two playing cards, and using a computer-based system, determining one or more of a birth card (BC) of the user and a planetary ruling card (PRC) of the user; if a desired connection is one or more of a friendship connection and a romantic connection, representing the user's birth card as M_{i,j}, where i and j are indices of one or more of a spiritual spread of the user and a life spread of the user:

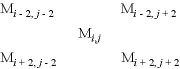

where M_{i,j} represents one or more of the user's BC and the user's PRC, and where M_{i-2,j-2},M_{i-2,j+2}, M_{i+2,j-2}, and M_{i+2,j+2} are diagonal elements that represent a successful reciprocal friendship/romantic relationship of the user's birth card; representing with blank cards birth cards near one or more of a corner and an edge of a spread that have diagonal element indices that fall outside the spread; removing the blank cards; using remaining elements, computing remaining compatible diagonal elements; and adding the compatible diagonal elements to the compatible cards array, so as to compute compatible diagonal elements for one or more of the user's BC and the user's PRC.

A computer-based method for finding a compatible partner for a user by computing compatible diagonal elements for the user's birth card, comprising: using one or more of a divination card system, a user's birthday and a standard deck of fifty-two playing cards, and using a computer-based system, determining one or more of a birth card (BC) of the user and a planetary ruling card (PRC) of the user; if a desired connection is a business connection, representing the user's birth card as M_{i,j}, where i and j are indices of one or more of a spiritual spread of the user and a life spread of the user:

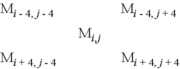

where M_{i,j} represents one or more of the user's BC and the user's PRC, and where M_{i-4,j-4}, M_{i-4,j+4}, M_{i+4,j-4}, and M_{i+4,j+4} are diagonal elements that represent a successful reciprocal business relationship of the user's birth card; representing with blank cards birth cards near one or more of a corner and an edge of a spread that have diagonal element indices that fall outside the spread; removing the blank cards; using remaining elements, computing remaining compatible diagonal elements; and adding the compatible diagonal elements to the compatible cards array, so as to compute compatible diagonal elements for one or more of the user's BC and the user's PRC.

A computer-based method for finding a compatible partner for a user includes: using a computer-based system, receiving the user's birthday from the user; computing a day of the year of the user's birthday; using the user's birthday, and using one or more of a divination card system, a user's birthday and a standard deck of fifty-two playing cards, determining one or more of the user's birth card (BC) and the user's planetary ruling card (PRC); using the user's BC and the user's PRC, producing a compatible cards array comprising one or more partner cards that are likely to correspond to a compatible partner for the user; computing compatible diagonal elements for the user's BC; computing a life path compatibility number (LPCN) for the user; computing an LPCN for the partner; comparing the partner list of the user with partner lists of the partner; comparing the LPCN of the user with the LPCN of the partner; using the results of the comparing step, adding to the user's compatible cards array; and outputting user information to the user.

### DESCRIPTION OF THE DRAWINGS

The accompanying drawings provide visual representations which will be used to more fully describe various representative embodiments and can be used by those skilled in the art to better understand the representative embodiments disclosed herein and their inherent advantages. In these drawings, like reference numerals identify corresponding elements.

FIG. 1 is a graph of birth card number against a day of the year on which a user's birthday falls.

FIG. 2 is a graph that plots the DayOfTheYear for each day in January (January 1^{st} through January 31st) verses a Card Number corresponding to the day.

FIG. 3 is a plot of the DayOfTheYear for each day in the year verses a Card Number corresponding to the day.

FIGS. 4A-4C are a set of three diagrams showing a spiritual spread and a life spread for the user and the computation of diagonal elements for one or more of the user's birth card and the user's planetary ruling card.

FIG. 5 is a flow chart of a method for finding a compatible partner for a user by computing compatible diagonal elements for one or more of the user's birth card and the user's planetary ruling card.

FIG. 6 is a flow chart of a method for finding a compatible partner for a user.

FIG. 7 is a flow chart of a method for finding a compatible partner for a user.

### DETAILED DESCRIPTION

Embodiments of the invention relate in general to a system and method for finding a compatible partner for a user. Further embodiments of the invention relate to a system and method for finding a compatible partner for a user, using a birthday of the user. Further embodiments of the invention relate to a system and method for finding a partner for a user that will be compatible with the user, using a birthday of the partner. Still further embodiments of the invention relate to a system and method for finding a compatible partner for a user, using a birthday of the user and using a birthday of the partner.

The system and method for finding a compatible partner for a user includes a plurality of components such as one or more of electronic components, hardware components, and computer software components. A number of such components can be combined or divided in the system. An example component of the system includes a set and/or series of computer instructions written in or implemented with any of a number of programming languages, as will be appreciated by those skilled in the art.

The system in one example employs one or more computer-readable signal-bearing media. The computer-readable signal bearing media store software, firmware and/or assembly language for performing one or more portions of one or more implementations of the invention. The computer-readable signal-bearing medium for the system in one example comprises one or more of a magnetic, electrical, optical, biological, and atomic data storage medium. For example, the computer-readable signal-bearing medium comprises floppy disks, magnetic tapes, CD-ROMs, DVD-ROMs, hard disk drives, downloadable files, files executable “in the cloud,” and electronic memory.

For example, the system comprises one or more of a mobile platform and an online platform. Embodiments of the invention employ a computational device. For example, the computational device comprises one or more of a computer, a mobile phone, a tablet, and another computational device.

According to embodiments of the invention, using one or more of a divination card system, a user's birthday and a standard deck of fifty-two playing cards, a system for finding a compatible partner for a user determines one or more of the user's birth card (BC) and the user's planetary ruling card (PRC). Preferably, although not necessarily, the system determines both the user's BC and the user's PRC. The system produces a list of compatible partners, the list comprising one or more cards corresponding to a compatible partner for the user.

Alternatively, or additionally, the system for finding a compatible partner for a user computes a life path compatibility number (LPCN) for the user. For example, using Pythagorean numerology, the system computes a life path compatibility number (LPCN) for the user. The system then lists an LPCN for a compatible partner compatible for the user.

System Input: The system accepts the user's birthday as input, then computes a day of the year of the user's birthday (ranging from 1 to 365 or 366 for leap years). For example, the system computes the day of the year of the user's birthday by first parsing an input string (using a date format of: MM/DD/YYYY) to compute the day of the year of his or her birthday (ranging from 1 to 365 or 366 for leap years). Optionally, the user enters the user's birthday and a partner's birthday. Using the user's birthday and the partner's birthday, the system computes one or more of the BC, the PRC, and the LPCN for one or more of the user and the partner. Using one or more of the BC, the PRC, and the LPCN for the one or more of the user and the partner, the system then finds one or more of a match and a non-match between the user and the partner.

The system is configured to receive user input that can initiate further input to the system. For example, the system can receive a request flag from a user. For example, the request flag initiates an additional filter used during the match process. For example, the system receives a business request flag from the user. For example, the system uses the business request flag to target the lists' connections toward business relationships.

For example, the request flag instructs the system to compute the user's LPCN. For example, the system then compares the user's LPCN with the partner's LPCN. For example, using Pythagorean numerology, the system then compares the user's LPCN with the partner's LPCN.

The system is configured to compute the user's BC. Alternatively, or additionally, the system is configured to compute the user's PRC. Alternatively, or additionally, the system is configured to compute the user's karma card. Alternatively, or additionally, the system is configured to compute the partner's BC. Alternatively, or additionally, the system is configured to compute the partner's PRC. Alternatively, or additionally, the system is configured to compute the partner's karma card.

The Birth Card: The system uses one or more of the user's birth month and birth day to determine one or more of the user's BC number and the user's BC name.

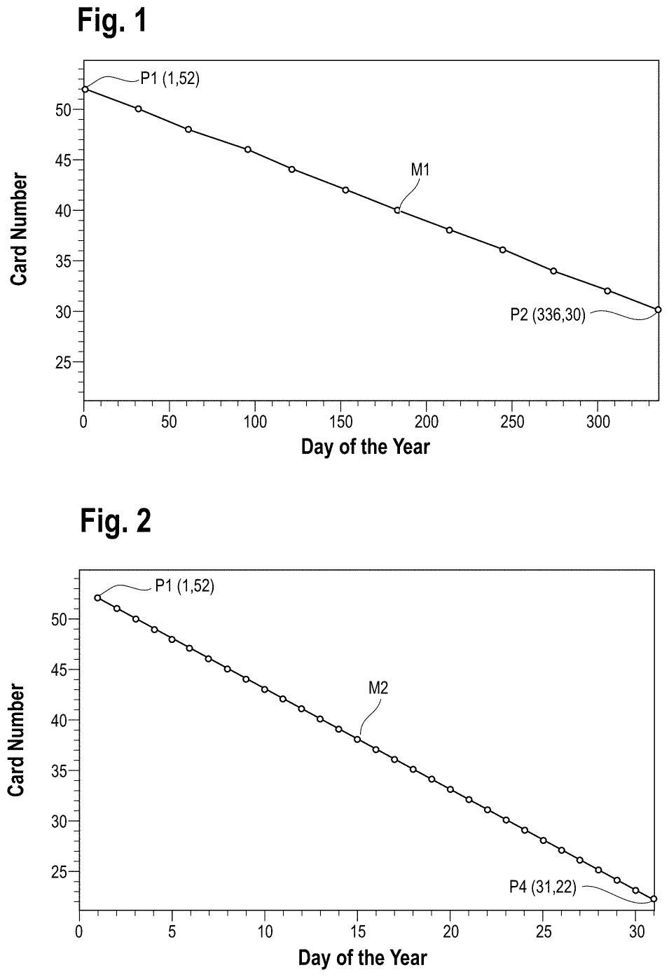

FIG. 1 is a graph of birth card number against a day of the year on which a user's birthday falls. As shown in FIG. 1, each day of the year is represented by a card comprised in a standard 52-playing card deck. The distribution of the cards in the spread, employing a unique numbering system, can be represented by two linear equations with an independent variable: the day of the year of his or her birth, and a dependent variable: the Birth Card Number.

The system computes the quantity FirstDayOfTheMonth, which is defined as an ordinal position in the yearly calendar occupied by the first day of each of the 12 months. For example, January 1 is the first day of the year, and so for January, FirstDayOfTheMonth=1. For example, February 1 is the 32^{nd} day of the year, and so for February, FirstDayOfTheMonth=32. Using a second equation, the system determines the user's birth card number (BCN) using the FirstDayOfTheMonth and the user's birthday.

The system defines an array, DayslnTheBirthMonth [31, Feb, 31, . . . ] containing twelve numbers representing the number of days in each month (using the current year to ascertain the number of days in February, 28 or 29 depending on whether it is a leap year). Then the system uses the user's Birth Month to loop through the array, adding each month's number of days to compute the FirstDayOfTheMonth.

The loop can be defined by the following Swift programming code:

var FirstDayOfTheMonth = 0
for var k in 0..< (BirthMonth−1) {

FirstDayOfTheMonth += DaysInTheMonth[k]
k += 1

}
FirstDayOfTheMonth += 1

The system adds one to the resulting total to compensate for the array's first element starting with zero instead of one.

FIG. 1 is a graph the system generates that plots the first day of each month (January 1st through December 1st) verses its Card Number. Using the point-slope form of a linear equation, the system solves for the slope of the line, m1.

y2−y1=m1*(x2−x1) 1)

m1=(y2−y1)/(x2−x1) 2)

The system represents a given point by a tuple (DayOfTheYear, Card-Number). The system represents the first point in FIG. 1, p1, by a tuple, (x1, y1). The system represents the second point in FIG. 1, p2, by a tuple (x2, y2). The point p1 represents the first day of January while the second point p2 represents the first day of December. The system represents the first tuple, p1 with a value of (1.0, 52.0). The system represents the second tuple, p2 with a value of (336.0, 30.0).

The system plugs these values for the first and second points into equation 2 above, producing the result:

m1=(30.0−52.0)/(336.0−1.0)=−0.06567164 3)

FIG. 2 is a graph that plots the DayOfTheYear for each day in January (January 1^{st} through January 31st) verses a Card Number corresponding to the day. Equation 3 represents the slope of the first days of the month line.

Next, using the first day of January: p1 (1, 52) and the point slope form, the system generates a linear equation for a FirstDaysCardNumber, which is defined as the card number for the first day of the user's birth month:

FirstDaysCardNumber=m1*(FirstDayOfTheMonth−1.0)+52.0 4)

Using the user's FirstDaysCardNumber, the system defines a point p3 representing the first day of the month as:

5)p3=(FirstDayOfTheBirthMonth, FirstDaysCardNumber), wherein FirstDayOfTheBirthMonth is defined as FirstDayOfTheMonth for the month of the user's birthday.

Now the system computes a Birth Card Number for the user's birthday. BCN's are related to the Day of the Year by a linear equation. First, the system computes a slope of this line. Using the first day of January, p1 (1, 52) and using the last day of January, p4 (31,22), the system computes a slope m2:

m2=(22.0−52.0)/(31.0−1.0)=−30.0/30.0=−1.0 6)

The slope for this line is a negative one.

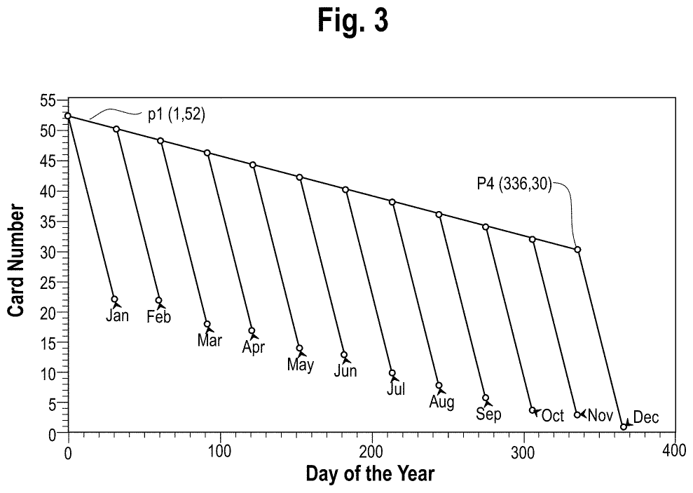

FIG. 3 is a plot of the DayOfTheYear for each day in the year verses a Card Number corresponding to the day. In fact, as shown in FIG. 3, the slope of the equation for each month is identical and is equal to −1.

Using the value of p3 and the slope (−1) in Equation 6, the system represents an expression for the day of birth and the birth card number by:

BirthCardNumber=−1.0*(DayOfTheYear−FirstDayOfTheMonth)+FirstDaysCardNumber.

Simplifying the above equation, rearranging the terms and solving for the BCN produces:

BirthCardNumber=FirstDayOfTheMonth−DayOfTheYear+FirstDaysCardNumber 7)

The system generates a deck array of integers comprising 52 cards laid out in 8 rows and 7 columns including four empty card positions:

[−1, −1, 52, 51, 50, −1, −1],

[07,06,05,04,03,02,01],

[14,13,12,11,10,09,08],

[21,20,19,18,17,16,15],

[28,27,26,25,24,23,22],

[35,34,33,32,31,30,29],

[42,41,40,39,38,37,36],

[49,48,47,46,45,44,43]

The card positions represented as −1 are empty. This array represents the card numbers (1-52) in relationship to their position in a card spread. Next the system defines a spiritual card dictionary that relates the BCN (a number from 1 to 52) to a matching Birth Card Name. The dictionary defines 52 tuples representing BCN's (the index) and Birth Card Names (a character string). The system can now determine the user's BC as follows:

Birth Card Name=SpiritualCardDictionary[BirthCardNumber] 8)

For example: if the user's birthday is May 31st, then the system computes his or her BCN as 14 and the Birth Card Name is defined by the dictionary as the ace of clubs.

Then the system defines an array (0-52) called the spiritual card deck representing character strings of card names. For example, SpiritualCardDeck[01] is the ace of hearts.

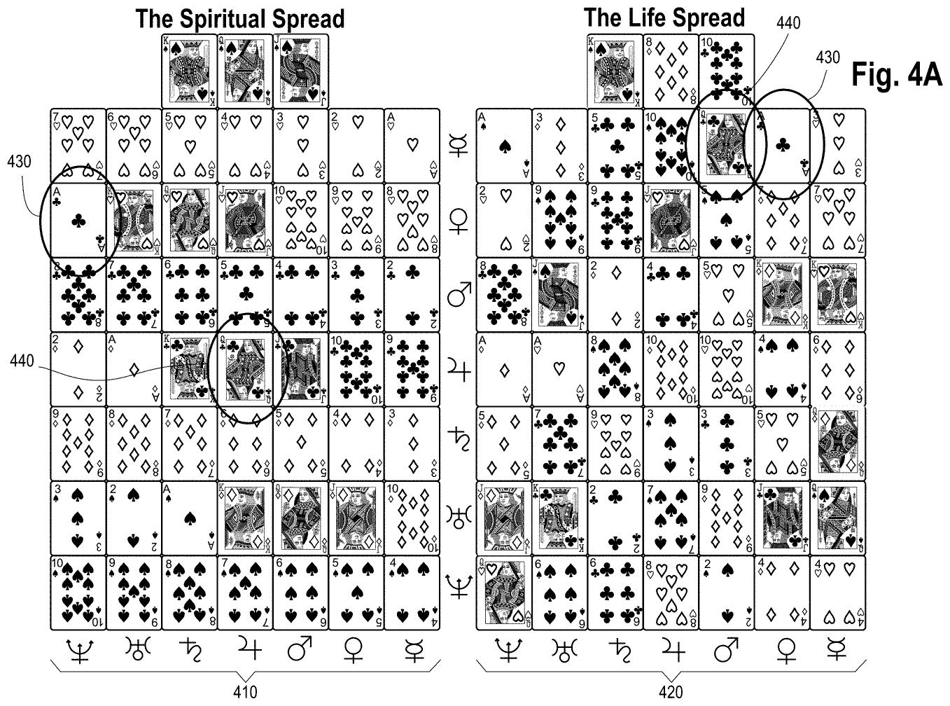

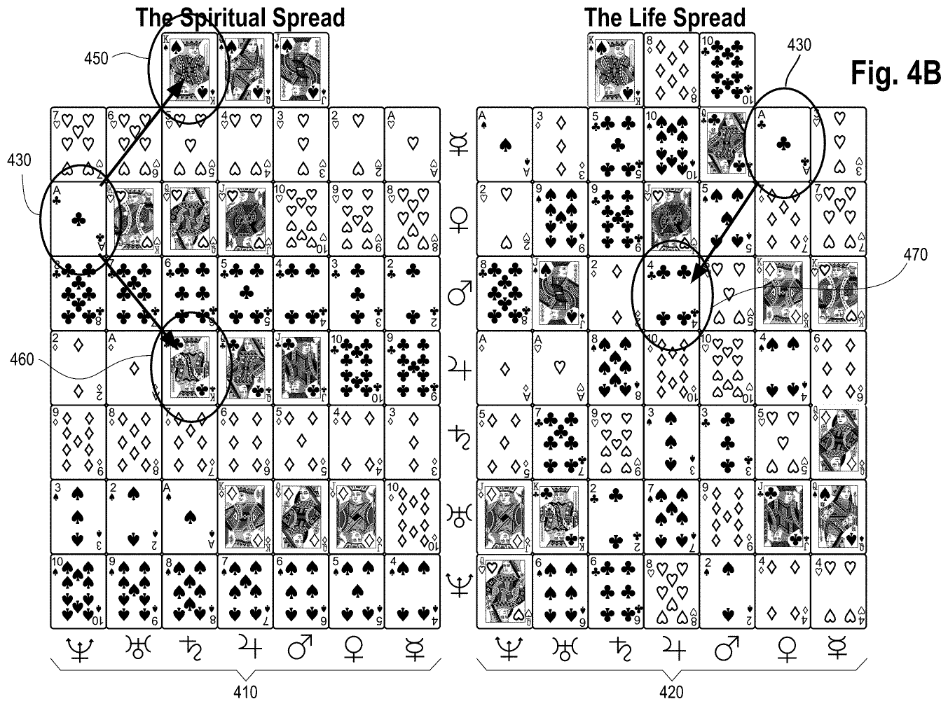

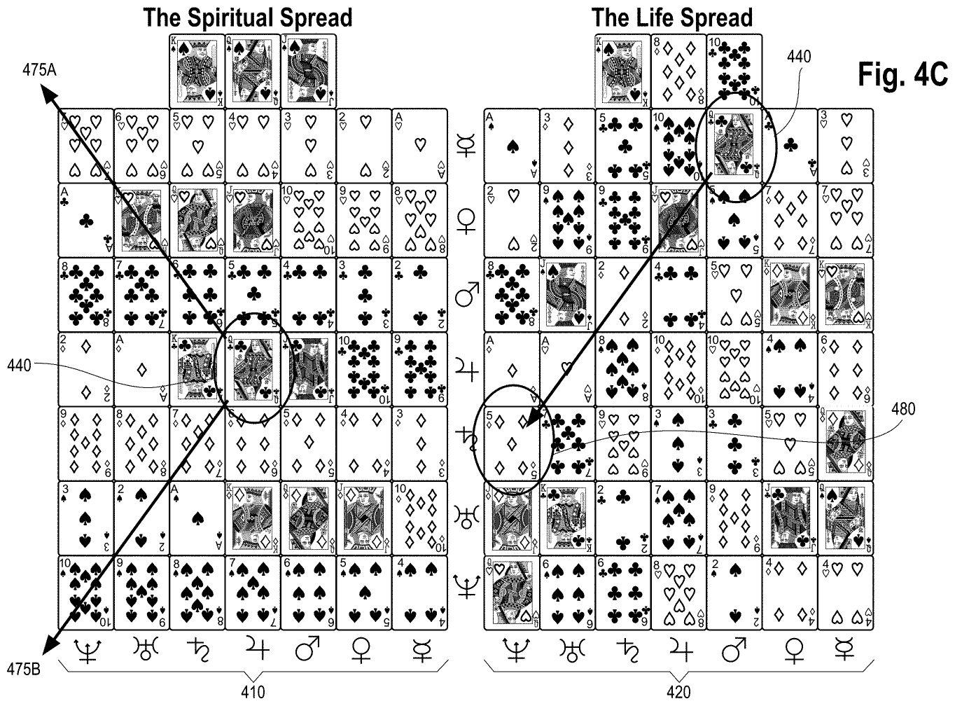

FIGS. 4A-4C are a set of three diagrams showing a spiritual spread and a life spread for the user and the computation of diagonal elements for one or more of the user's birth card and the user's planetary ruling card.

FIG. 4A shows the resulting spiritual spread 410 along with a life spread 420, discussed below.

Using the spiritual spread 410, the system computes compatible diagonal elements:

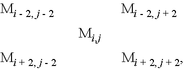

where M_{i,j} represents the user's BC, where i and j are indices of one or more of the user's spiritual spread 410 and the user's life spread 420, and the other four cards (M_{i-2,j-2,}M_{i-2,j+2}, M_{i+2,j-2}, and M_{i+2,j+2}) are diagonal elements that represent one or more of a successful reciprocal friendship of the user's birth card and a successful reciprocal romantic relationship of the user's birth card. These diagonal cards are two cards away from the user's birth card in diagonal directions. They are represented by the user's Venus planetary offset of two.

In the example already mentioned, the user's birthday is May 31^{st}. For that birthday, the system determines that the user's BC 430 is the ace of clubs and that the user's PRC 440 is the queen of clubs.

FIG. 4B illustrates the process, using the user's BC 430, and using the spiritual spread 410 and the life spread 420, for finding the user's diagonal elements having a Venus offset for successful reciprocal love and friendship connections. In the spiritual spread 410, cards two cards away diagonally from the user's BC 430, the ace of clubs, are a first spiritual spread Venus offset diagonal element 450, the king of spades, and a second spiritual spread Venus offset diagonal element 460, the king of clubs. Similarly, in the life spread 420, cards two cards away diagonally from the user's BC 430 are a first life spread Venus offset diagonal element 470, the four of clubs. The user's PRC 440 is used similarly to compute other Venus offset diagonal elements for both spreads.

FIG. 4C illustrates the process, using the user's PRC 440, and using the spiritual spread 410 and the life spread 420, for finding the user's diagonal elements having a Jupiter offset for successful reciprocal business connections. In the spiritual spread 410, as shown by the arrows 475A and 475B, there are no cards four cards away diagonally from the user's PRC 440, the queen of clubs. In the life spread, cards four cards away diagonally from the user's PRC 440 are a first spiritual spread Jupiter offset diagonal element 480, the five of diamonds. The user's BC 430 is used similarly to compute other Jupiter offset diagonal elements for both spreads.

In addition to the beneficial offset of Venus representing a friendship connection, there is also an additional valuable planetary influence, Jupiter, which represents a profitable business connection. However, these diagonal cards are four cards away in diagonal directions from the user's Birth Card. The profitable business connection cards are represented by the user's Jupiter planetary offset of four:

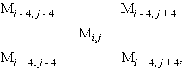

where M_{i,j} represents the user's BC, where i and j are indices of one or more of the user's spiritual spread and the user's life spread, and the other four cards (M_{i-4,j-4}, M_{i-4,j+4}, M_{i+4,j-4}, and M_{i+4,j+4}) are diagonal elements that represent a successful reciprocal business relationship of the user's birth card.

Birth cards near a corner or edge of a spread will have diagonal element indices that fall outside the spread; the system represents these by blank cards. The system then removes the blank cards. Using the remaining elements, the system begins building an array of compatible cards known as the compatible cards array.

Next the system adds fixed and semi-fixed cards to the compatible cards array. For example, the system adds fixed and semi-fixed cards to the compatible cards array if one or more of a user's birth card and a user's planetary ruling card comprises one or more of a fixed card and a semi-fixed card. For example, the system adds fixed and semi-fixed cards to the compatible cards array only if one or more of a user's birth card and a user's planetary ruling card comprises one or more of a fixed card and a semi-fixed card. For example, the system adds fixed and semi-fixed cards to the compatible cards array if and only if one or more of a user's birth card and a user's planetary ruling card comprises one or more of a fixed card and a semi-fixed card.

As illustrated in FIGS. 4A-4C, in addition to the spiritual spread, there is a complementary deck called the life spread with different card assignments. Cards that do not change position between the two spreads, for example, the king of spades (card 52), the jack of hearts (card 11) and the eight of clubs (card 21) are called fixed cards. Pairs of cards that interchange positions between the two decks are called semi-fixed cards. For example, the two of hearts (card 2 in the spiritual deck, card 14 in the life spread) and the ace of clubs (card 14 in the spiritual Spread and card 2 in the life spread) are semi-fixed cards. For example, the seven of diamonds (card 33 in the spiritual spread and card 9 in the life spread) and the nine of hearts (card 9 in the spiritual spread and card 33 in the life spread) are semi-fixed cards. If any of these cards matches the user's birth card, that is, if one or more of a fixed card and a semi-fixed card matches the user's birth card, the system adds the one or more of a matching fixed card and a matching semi-fixed card to the user's compatible cards array. If the system finds that the user's card number matches one or more of a fixed card and a semi-fixed card, the system adds these cards to the user's compatible cards array.

The system defines a life spread and a life dictionary that contains tuples: the Life Card Name and the BCN. Using one or more of the life spread and the spiritual spread, the system finds indices of the birth card in the life spread. Preferably, using the life spread and the spiritual spread, the system finds indices of the birth card in the life spread. The system appends the fixed and semi-fixed cards to the compatible cards array. The system then removes the blank cards. For example, the system removes all the blank cards.

Planetary ruling card: To compute the user's PRC, the system has to ascertain the user's zodiac sign. The system determines this quite easily by using the day of birth computed earlier and a zodiac sign range table. In the example above, the system determines that the user's May 31^{st} birthday falls on the 152nd day of the year. The system further determines that the 152^{nd} day lies within a range from 140 to 171, which is associated with a Gemini. Therefore, the system determines that the user's zodiac sign is Gemini.

Next the system defines a dictionary that matches the user's zodiac sign with a planetary offset. The system defines the planetary offset as the planet's position from the Sun in our solar system. The system defines the Moon's offset as −1, the Sun's offset as 0, Mercury's offset as 1, and Venus' offset as 2. The system does not count Earth in determining the offset. The system defines Mars' offset as 3, Jupiter's offset as 4, Saturn's offset as 5, Uranus' offset as 6, Neptune's offset as 7 and lastly, Pluto's offset as 8.

The system defines a dictionary called the ZodiacDictionary that relates the user's zodiac sign to the defined planetary ruling offset. The system then uses this offset on both the BCN and a life card number to determine a PRC number. The system then uses the IPRC name to determine the position of the planetary ruling card in the spiritual spread.

Next the system finds diagonal elements of these cards and appends the diagonal elements to the compatible cards array. Lastly, the system removes the blank cards. For example, the system removes all the blank cards.

In some cases, the system must process more then one PRC. In such cases, the system loops through the PRC logic for each card. For example, the system may loop through the zodiac sign Scorpio two times.

Next, the system determines one or more of diagonal elements, fixed cards, and semi-fixed cards and adds them to the compatible cards array. For example, the system adds to the compatible cards array the one or more of diagonal elements, fixed cards, and semi-fixed cards if the BC and or PRC are fixed or semi-fixed cards to the compatible cards array. For example, the system adds to the compatible cards array the one or more of diagonal elements, fixed cards, and semi-fixed cards only if the BC and or PRC are fixed or semi-fixed cards to the compatible cards array. For example, the system adds to the compatible cards array the one or more of diagonal elements, fixed cards, and semi-fixed cards if and only if the BC and or PRC are fixed or semi-fixed cards to the compatible cards array. Finally, the system removes the blank cards. For example, the system removes all the blank cards.

The karma card: The system generates a karma card for the user by indexing into each spread array using a complementary index. For example, the karma card comprises one or more of a karma spiritual birth card, a karma life birth card, and a karma life planetary ruling (PR) card, and a karma spiritual PR card. For example, to generate the karma spiritual birth card, the system indexes the life spread with a spiritual birth card number. Similarly, to generate the karma life birth card, the system indexes the spiritual spread with the life card number. Similarly, to generate the karma life PR card, the system indexes the spiritual spread with a life PRC number. Similarly, to generate the karma spiritual PR card, the system indexes the life spread with a spiritual PRC number.

Then optionally the system appends one or more karma cards to the compatible cards array. For example, the system appends one or more karma cards to the compatible cards array if one or more of the user's BC and the user's PRC comprises one of a fixed card and a semi-fixed card. For example, the system appends one or more karma cards to the compatible cards array only if one or more of the user's BC and the user's PRC comprises one of a fixed card and a semi-fixed card. For example, the system appends one or more karma cards to the compatible cards array if and only if one or more of the user's BC and the user's PRC comprises one of a fixed card and a semi-fixed card.

Then the system removes one or more of duplicate cards and blank cards—from the compatible cards array. For example, the system removes all duplicate cards—from the compatible cards array. For example, the system removes all blank cards from the compatible cards array.

Then the system removes strings of cards matching one or more of the user's birth card name and PRC name. Preferably, the system removes strings of cards matching one of the user's birth card name and PRC name.

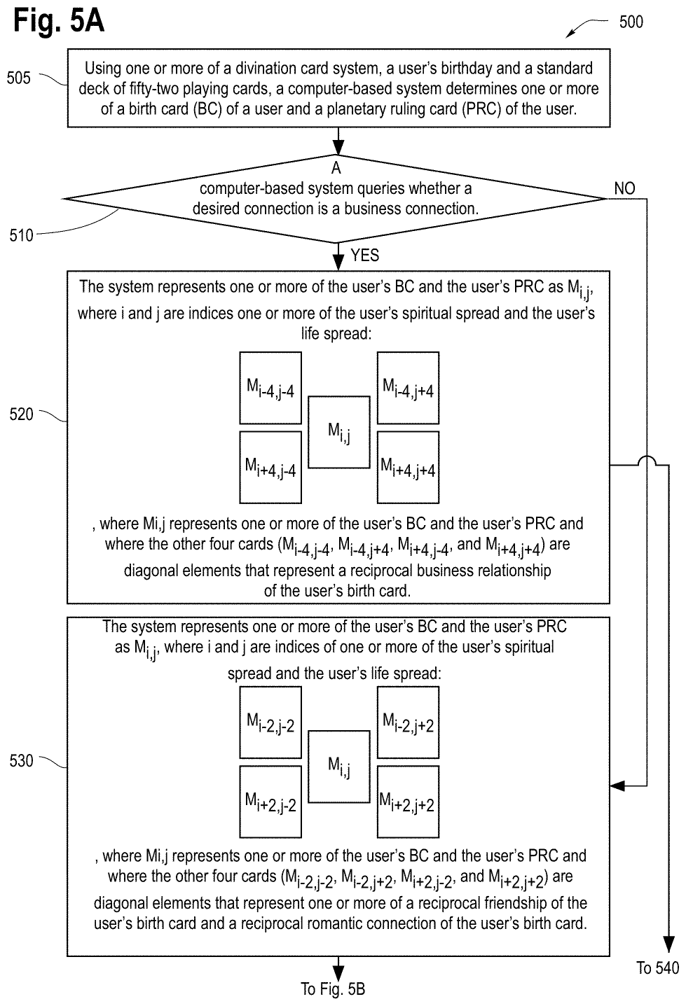

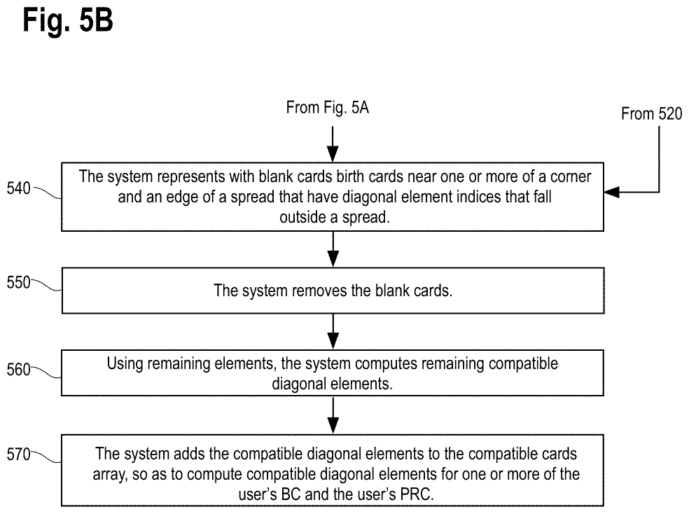

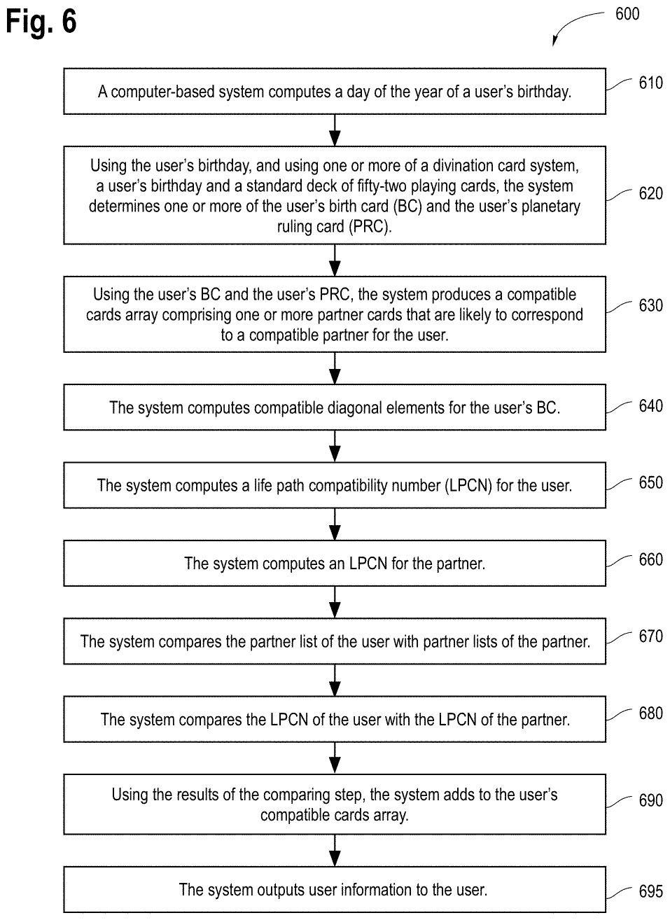

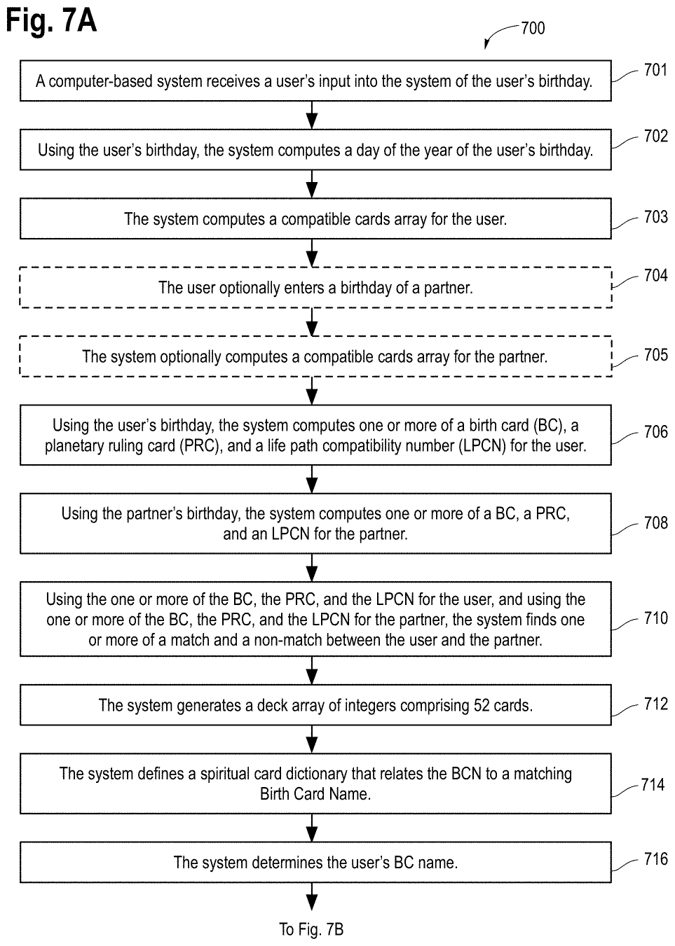

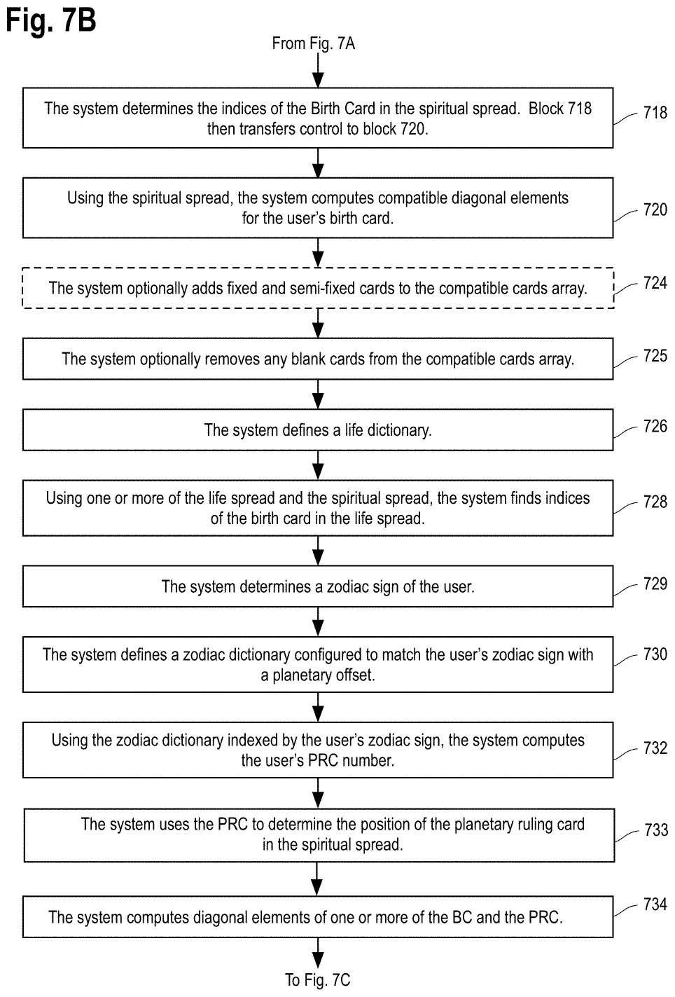

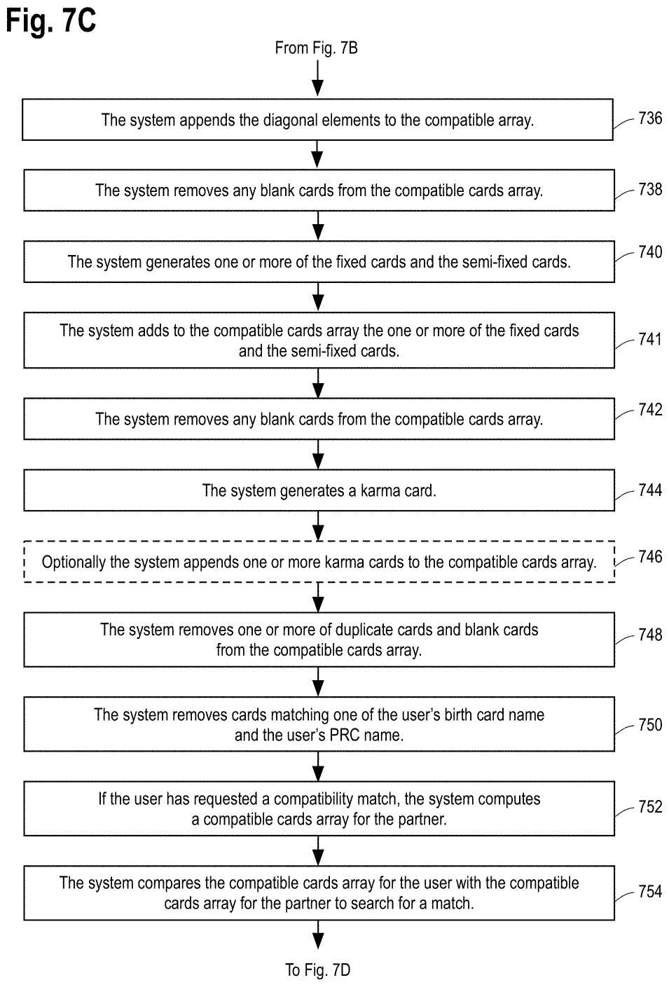

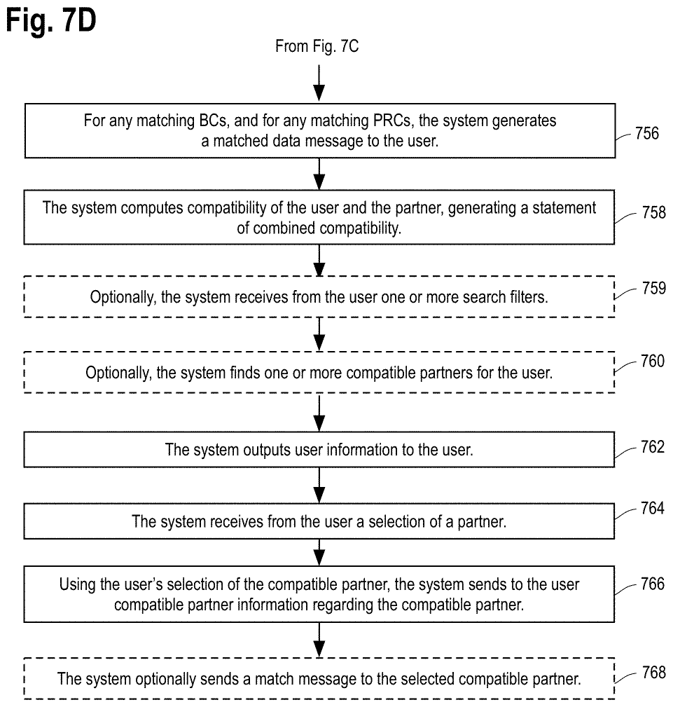

FIG. 5 is a flow chart of a method for finding a compatible partner for a user by computing compatible diagonal elements for one or more of a user's birth card and a user's planetary ruling card. FIG. 5 depicts sub-steps of the step of computing diagonal elements for a user's birth card, which is step 640 in FIG. 6 and is also step 720 in FIG. 7.

The order of the steps in the method 500 is not constrained to that shown in FIG. 5 or described in the following discussion. Several of the steps could occur in a different order without affecting the final result.

In step 505, using one or more of a divination card system, a user's birthday and a standard deck of fifty-two playing cards, a computer-based system determines one or more of a birth card (BC) of a user and a planetary ruling card (PRC) of the user. Block 505 then transfers control to block 510.

In step 510, a system queries whether a desired connection is a business connection. If yes, the system proceeds to step 520. If no, the system proceeds to step 530.

In step 520, the system represents one or more of the user's BC and the user's PRC as M_{i,j}, where i and j are indices of one or more of the user's spiritual spread and the user's life spread:

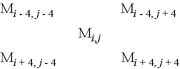

Here M_{i,j} represents one or more of the user's BC and the user's PRC and the other four cards (M_{i-4,j-4},M_{i-4,j+4}, M_{i+4,j-4}, and M_{i+4,j+4}) are diagonal elements that represent a reciprocal business relationship of the user's birth card. These diagonal cards are four cards away from the user's birth card in diagonal directions, corresponding to a Jupiter planetary offset of four. Diagonal elements four cards away from the user's birth card in diagonal directions represent the user's Jupiter planetary offset of four and are used to determine a business connection. Block 520 then transfers control to block 540.

In step 530, the system represents the user's birth card as M_{i,j}, where i and j are indices of the user's spiritual spread:

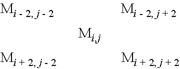

Here M_{i,j} represents one or more of the user's BC and the user's PRC and the other four cards (M_{i-2,j-2},M_{i-2,j+2}, M_{i+2,j-2}, and M_{i+2,j+2}) are diagonal elements that represent one or more of a reciprocal friendship of the user's birth card and a reciprocal romantic connection of the user's birth card. These diagonal cards are two cards away from the user's birth card in diagonal directions, corresponding to a Venus planetary offset of two. Diagonal elements two cards away from one or more of the user's birth card and planetary ruling cards in diagonal directions represent the user's Venus planetary offset of two and are used to determine one or more of a friendship connection and a romantic connection. Block 530 then transfers control to block 540.

In step 540, the system represents with blank cards birth cards near one or more of a corner and an edge of a spread that have diagonal element indices that fall outside the spread. Block 540 then transfers control to block 550.

In step 550, the system removes the blank cards. Block 550 then transfers control to block 560.

In step 560, using remaining elements, the system computes remaining compatible diagonal elements. Block 560 then transfers control to block 570.

In step 570, the system adds the compatible diagonal elements to the compatible cards array, so as to compute compatible diagonal elements for one or more of the user's BC and the user's PRC. Preferably, although not necessarily, the system computes diagonal elements for both the user's BC and the user's PRC. Block 570 then terminates the process.

FIG. 6 is a flow chart of a method for finding a compatible partner for a user.

The order of the steps in the method 600 is not constrained to that shown in FIG. 6 or described in the following discussion. Several of the steps could occur in a different order without affecting the final result.

In step 610, a computer-based system computes a day of the year of a user's birthday. Block 610 transfers control to block 620.

In step 620, using the user's birthday, and using one or more of a divination card system, a user's birthday and a standard deck of fifty-two playing cards, the system determines one or more of the user's birth card (BC) and the user's planetary ruling card (PRC). Preferably, although not necessarily, the system determines both the user's BC and the user's PRC. Block 620 then transfers control to block 630.

In step 630, using the user's BC and the user's PRC, the system produces a compatible cards array comprising one or more partner cards that are likely to correspond to a compatible partner for the user. Block 630 then transfers control to block 640.

In step 640, the system computes compatible diagonal elements for the user's BC. FIG. 5 provides further detail on this step. Block 640 then transfers control to block 650.

In step 650, the system computes a life path compatibility number (LPCN) for the user. Block 650 then transfers control to block 660.

In step 660, the system computes an LPCN for the partner. Block 660 then transfers control to block 670.

In step 670, the system compares the partner list of the user with partner lists of the partner. Block 670 then transfers control to block 680.

In step 680, the system compares the LPCN of the user with the LPCN of the partner. Block 680 then transfers control to block 690.

In step 690, using the results of the comparing step 670, the system adds to the user's compatible cards array. Block 690 then transfers control to block 695.

In step 695, the system outputs user information to the user.

FIG. 7 is a flow chart of a method 700 for finding a compatible partner for a user.

The order of the steps in the method 700 is not constrained to that shown in FIG. 7 or described in the following discussion. Several of the steps could occur in a different order without affecting the final result.

In step 701, a computer-based system receives a user's input into the system of the user's birthday. The system accepts the user's birthday as input. Block 701 then transfers control to block 702.

In step 702, using the user's birthday, the system computes a day of the year of the user's birthday. The day of the year of the user's birthday ranges from 1 to 365 for non-leap years. The day of the user's birthday ranges from 1 to 366 for leap years. For example, the system computes the day of the year of the user's birthday by parsing the user's birthday. For example, in parsing the user's birthday, the system uses a date format of: MM/DD/YYYY. For example, in parsing the user's birthday, the system uses a date format of: YYYYMMDD. For example, in parsing the user's birthday, the system uses another date format. For example, in parsing the partner's birthday, the system uses a date format of: DD/MM/YYYY. Block 702 then transfers control to block 703.

In step 703, the system computes a compatible cards array for the user. Block 703 then transfers control to block 704.

In step 704, the user optionally enters a birthday of a partner. For example, the partner comprises a candidate partner. For example, the partner comprises an established partner. The system accepts the partner's birthday as input. Using the partner's birthday, the system computes a day of the year of the partner's birthday. The day of the year of the partner's birthday ranges from 1 to 365 for non-leap years. The day of the partner's birthday ranges from 1 to 366 for leap years. For example, the system computes the day of the year of the partner's birthday by parsing the partner's birthday. For example, in parsing the partner's birthday, the system uses a date format of: MM/DD/YYYY. For example, in parsing the partner's birthday, the system uses a date format of: YYYYMMDD. For example, in parsing the partner's birthday, the system uses another date format. Block 704 then transfers control to block 705.

In step 705, the system optionally computes a compatible cards array for the partner. Block 705 then transfers control to block 706.

In step 706, using the user's birthday, the system computes one or more of a BC, a PRC, and an LPCN for the user. Preferably, the system computes the BC for the user, the PRC for the user, and the LPCN for the user. Block 706 then transfers control to block 708.

In step 708, using the partner's birthday, the system computes one or more of a BC, a PRC, and an LPCN for the partner. Preferably, the system computes the BC for the partner, the PRC for the partner, and the LPCN for the partner. Optionally, the system further computes the user's karma card. Block 708 then transfers control to block 710.

In step 710, using the one or more of the BC, the PRC, and the LPCN for the user, and using the one or more of the BC, the PRC, and the LPCN for the partner, the system finds one or more of a match and a non-match between the user and the partner. Block 710 then transfers control to block 712.

In step 712, the system generates a deck array of integers comprising 52 cards. For example, the deck array comprises 52 cards laid out in 7 rows and 7 columns including four empty card positions. For example, the deck array comprises a spiritual spread. Block 712 then transfers control to block 714.

In step 714, the system defines a spiritual card dictionary that relates the BCN (a number from 1 to 52) to a matching Birth Card Name. For example, the spiritual card dictionary defines 52 tuples representing BCN's (the index) and Birth Card Names (a character string). Block 714 then transfers control to block 716.

In step 716, the system determines the user's BC name. For example, the system determines the user's BC name using the equation:

Birth Card Name=SpiritualCardDictionary[BirthCardNumber] 8)

For example: if the user's birthday is May 31st, then the system computes his or her BCN as 14. Using the spiritual card dictionary, the system determines that the user's Birth Card Name is the ace of clubs. Block 716 then transfers control to block 718.

In step 718, the system determines the indices of the Birth Card in the spiritual spread. Block 718 then transfers control to block 720.

In step 720, using the spiritual spread, the system computes compatible diagonal elements for the user's birth card. FIG. 5 provides further detail on this step.

The system computes one or more of diagonal Venus elements and diagonal Jupiter elements. Preferably, the system computes one of diagonal Venus elements and diagonal Jupiter elements. Diagonal elements two cards away from the user's birth card in diagonal directions represent the user's Venus planetary offset of two and are used to determine one or more of a friendship connection and a romantic connection. Diagonal elements four cards away from the user's birth card in diagonal directions represent the user's Jupiter planetary offset of four and are used to determine a business connection.

Birth cards near a corner or edge of a spread will have diagonal element indices that fall outside the spread; the system represents these by blank cards.

The system removes any blank cards from the compatible cards array. Using the remaining elements, the system continues building the compatible cards array. The system appends the diagonal elements to the user's compatible cards array. Block 720 then transfers control to block 724.

In step 724, the system optionally adds fixed and semi-fixed cards to the compatible cards array. For example, the system adds fixed and semi-fixed cards to the compatible cards array if one or more of a user's BC and a user's PRC comprises one or more of a fixed card and a semi-fixed card. For example, the system adds fixed and semi-fixed cards to the compatible cards array only if one or more of a user's BC and a user's PRC comprises one or more of a fixed card and a semi-fixed cards. For example, the system adds fixed and semi-fixed cards to the compatible cards array if and only if one or more of a user's BC and a user's PRC comprises one or more of a fixed card and a semi-fixed card. For example, the system adds fixed and semi-fixed cards to the compatible cards array if and only if the user's BCN comprises one of 2, 9, 11, 14, 21, 33, and 62.

For example, the system adds fixed and semi-fixed cards to the user's compatible cards array if the one or more of a fixed card and a semi-fixed card matches the user's birth card. For example, the system adds fixed and semi-fixed cards to the user's compatible cards array only if the one or more of a fixed card and a semi-fixed card matches the user's birth card. For example, the system adds fixed and semi-fixed cards to the user's compatible cards array if and only if the one or more of a fixed card and a semi-fixed card matches the user's birth card.

For example, the system adds fixed and semi-fixed cards to the user's compatible cards array if the one or more of a fixed card and a semi-fixed card matches the user's birth card number. For example, the system adds fixed and semi-fixed cards to the user's compatible cards array only if the one or more of a fixed card and a semi-fixed card matches the user's birth card number. For example, the system adds fixed and semi-fixed cards to the user's compatible cards array if and only if the one or more of a fixed card and a semi-fixed card matches the user's birth card number. Block 724 then transfers control to block 725.

In step 725, the system removes any blank cards from the compatible cards array. Block 725 then transfers control to block 726.

In step 726, the system defines a life dictionary. For example, the system defines a life dictionary comprising an array of tuples. For example, the system defines a life dictionary comprising an array of tuples, at least one of the tuples comprising the Life Card Name and the BCN. Block 726 then transfers control to block 728.

In step 728, using one or more of the life spread and the spiritual spread, the system finds indices of the birth card in the life spread. Preferably, using the life spread and the spiritual spread, the system finds indices of the birth card in the life spread. Block 728 then transfers control to block 729.

In step 729, the system determines a zodiac sign of the user. For example, the system determines the user's zodiac sign using one or more of the user's day of birth and a zodiac sign range table. For example, the system determines the user's zodiac sign using both the user's day of birth and the zodiac sign range table.

In step 730, the system defines a zodiac dictionary configured to match the user's zodiac sign with a planetary offset. The system defines the planetary offset as the planet's position from the Sun in our solar system. For example, the system defines the Moon's offset as −1. For example, the system defines the Sun's offset as 0. For example, the system defines Mercury's offset as 1. For example, the system defines Venus' offset as 2. For example, the system does not count Earth in determining the offset. For example, the system defines Mars' offset as 3. For example, the system defines Jupiter's offset as 4. For example, the system defines Saturn's offset as 5. For example, the system defines Uranus' offset as 6. For example, the system defines Neptune's off-set as 7. For example, the system defines Pluto's offset as 8. Block 730 then transfers control to block 732.

In step 732, using the zodiac dictionary indexed by the user's zodiac sign, the system computes the user's PRC number. For example, using the zodiac dictionary indexed by the user's zodiac sign, the system computes the user's PRC number. For example, the system computes the user's PRC number using the user's day of birth computed earlier and using a zodiac sign range table. In some cases, the system must process more then one PRC. In such cases, the system loops through the PRC logic for each card. For example, the system may loop through the zodiac sign Scorpio two times. Block 732 then transfers control to block 733.

In step 733, the system uses the PRC to determine the position of the planetary ruling card in the spiritual spread. Block 733 then transfers control to block 734.

In step 734, the system computes diagonal elements of one or more of the BC and the PRC. Block 734 then transfers control to block 736.

In step 736, the system appends the diagonal elements to the compatible cards array. Block 736 then transfers control to block 738.

In step 738, the system removes any blank cards from the compatible cards array. Block 738 then transfers control to block 740.

In step 740, the system generates one or more of the fixed cards and the semi-fixed cards. Block 740 then transfers control to block 741.

In step 741, the system adds to the compatible cards array the one or more of the fixed cards and the semi-fixed cards. Block 741 then transfers control to block 742.

In step 742, the system removes any blank cards from the compatible cards array. Block 742 then transfers control to block 744.

In step 744, the system generates a karma card. For example, the karma card comprises one or more of a karma spiritual birth card, a karma life birth card, a karma life planetary ruling (PR) card, and a karma spiritual PRC.

For example, the system generates the karma spiritual birth card by indexing into the spiritual spread using the life card number. For example, the system generates the karma life birth card by indexing into the life spread using the BCN. For example, the system generates the karma spiritual birth card by indexing into the life spread using the spiritual birth card number.

For example, the system generates the karma life PRC by indexing into the spiritual spread using the life PRC number. Similarly, to generate the karma spiritual PR card, the system indexes the life spread with the spiritual PRC number. Block 744 then transfers control to block 746.

In step 746, optionally the system appends one or more karma cards to the compatible cards array. For example, the system appends all the karma cards to the compatible cards array. For example, the system appends one or more karma cards to the compatible cards array if one or more of the user's BC and the user's PRC comprises one or more of a fixed card and a semi-fixed card. For example, the system appends one or more karma cards to the compatible cards array only if the user's BC and or PRC are fixed or semi-fixed cards fixed and semi-fixed cards. For example, the system appends one or more karma cards to the compatible cards array if and only if a user's BC and or PRC are fixed or semi-fixed cards. Block 746 then transfers control to block 748.

In step 748, the system removes one or more of duplicate cards and blank cards from the compatible cards array. For example, the system removes all duplicate cards from the compatible cards array. For example, the system removes all blank cards from the compatible cards array. For example, the system removes all duplicate cards and all blank cards from the compatible cards array. Block 748 then transfers control to block 750.

In step 750, the system removes cards matching one of the user's birth card name and the user's PRC name. Block 750 then transfers control to block 752.

In step 752, if the user has requested a compatibility match, the system computes a compatible cards array for the partner. Block 752 then transfers control to block 754.

In step 754, the system compares the compatible cards array for the user with the compatible cards array for the partner to search for a match. For example, the system compares the two arrays to determine if a match exists between the BC's. For example, the system compares the two arrays to determine if a match exists between the PRC's. For example, the system compares the user's compatible cards array with one or more of the partner's BC and the partner's PRC. For example, the system compares the user's compatible cards array with both the partner's BC and the partner's PRC. Alternatively, or additionally, the system compares the partner's compatible cards array with one or more of the user's BC and the user's PRC. For example, alternatively, or additionally, the system compares the partner's compatible cards array with both the user's BC and the user's PRC. Block 754 then transfers control to block 756.

In step 756, for any matching BCs, and for any matching PRCs, the system generates a matched data message to the user. Optionally, the matched data message is also transmitted to the partner. Block 756 then transfers control to block 758.

In step 758, the system computes compatibility of the user and the partner, generating a statement of combined compatibility. Block 758 then transfers control to block 759.

In step 759, optionally, the system receives from the user one or more search filters. For example, the search filters comprise one or more of height preference, sexual preference, national preference, regional preference, race preference, age range preference, and other preferences. Block 759 then transfers control to block 760. In step 760, optionally, the system finds one or more compatible partners for the user. Block 760 then transfers control to block 762.

In step 762, the system outputs user information to the user. For example, the user information comprises one or more of the user's BC, the user's PRC, the user's zodiac sign, the user's LPCN, and the user's compatible cards array. The user information further comprises a statement of combined compatibility.

Optionally, the user information comprises numerical matches to the partner's birthday. Optionally, the user information comprises one or more of the partner's BC, the partner's PRC, the partner's zodiac sign, the partner's LPCN, and the partner's compatible cards array.

Optionally, the user information further comprises a matrix of information regarding the compatible partner. For example, the user information comprises one or more of the compatible partner's name, the compatible partner's gender, the compatible partner's age, the compatible partner's height, the compatible partner's geographic location, the compatible partner's sexual orientation, the compatible partner's race, a photograph of the compatible partner, an audio file of the compatible partner, a video file of the compatible partner, a connection of the compatible partner to the user, a personal profile of the compatible partner, one or more compatible partners of the compatible partner, a BCN of the compatible partner, an LPCN of the compatible partner, a zodiac sign of the compatible partner, a karma card of the compatible partner, and a contact means for the user to contact the compatible partner. Block 762 transfers control to block 764.

In step 764, the system receives from the user a selection of a partner. Block 764 then transfers control to block 766.

In step 766, using the user's selection of the compatible partner, the system sends to the user compatible partner information regarding the compatible partner. For example, the compatible partner information comprises one or more of the compatible partner's name, the compatible partner's gender, the compatible partner's age, the compatible partner's sexual orientation, the compatible partner's race, a photograph of the compatible partner, an audio file of the compatible partner, a video file of the compatible partner, a connection of the compatible partner to the user, a personal profile of the compatible partner, one or more compatible partners of the compatible partner, a BCN of the compatible partner, an LPCN of the compatible partner, a zodiac sign of the compatible partner, a karma card of the compatible partner, and a contact means for the user to contact the compatible partner. the compatible partner information comprises one or more of a personal profile of the compatible partner, one or more compatible partners of the compatible partner, and an LPCN of the compatible partner. Block 766 transfers control to block 768.

In step 768, the system optionally sends a match message to the selected compatible partner. For example, the match message comprises the profile of the user. The system receives from the compatible partner one or more of an acceptance of the user and a rejection of the user. Block 768 then terminates the process.

Upon a user request, the system can perform a second match to find an LPCN, based on the Pythagorean numerology matrix, using the user's birthday and the partner's birthday. The system represents the 3×3 matrix as a LifePathCompatabilityMatrix:

[1, 5, 7],

[2, 4, 8],

[3, 6, 9]

The system computes the LPCN using the numbers in the birthday. For example, the user's birthday is: May 31, 1961 and is represented by numerals: 05/31/1961 (formatted as: MM/DD/YYYY), representing the three stages of life. The system adds the numerals in the birthday, for example: 5+[3+1]+[1+9+6+1]=5+4+17=26=2+6=8. So the system computes the user's LPCN to be 8. The system determines that the user is compatible with other people with LPCNs in the same row; in the example row two: (2, 4 and 8) or, as in this case, column three (7, 8 and 9, a special case for the LPCN of 8).

In addition, the system includes an array of numbers (see below) coresponding to partners that are to a lesser extent compatible. The x's are places holders that do not count.

LifeCompatibilityArray[[3, 9, x],

[3, 6, x],

[1, 2, 5],

[6, 7, x],

[3, 9, x],

[2, 4, 8],

[x, 4, x],

[x, 6, x],

[1, 5, x]]

As user information output by the system, the user will receive his or her birth card, planetary ruling card and their compatible cards array plus optional matches to a second input birthdate. The compatible cards array is a collection of birth card names that will be compatible with the user's birth card. The output also includes the LPCN as well as optional numerical matches to the second Birthdate. A statement of this combined compatibility will be displayed.

In the example of the user with the May 31^{st} birthday, the system sends the user the user's birth card, which comprises the ace of clubs. The system sends the user the user's planetary ruling card, which comprises the queen of clubs. The system sends the user the user's zodiac sign, which comprises Gemini. The system sends the user the user's compatible cards array. The user's compatible cards array comprises the king of spades, the king of clubs, the jack of hearts, the eight of clubs, the nine of hearts, the seven of diamonds, the two of hearts, the four of clubs, the two of diamonds, the king of hearts, the two of spades, the jack of diamonds, the three of hearts and lastly, the ten of diamonds. The system sends the user the user's LPCN of 8. Optionally, if the user input a second birthday, the system sends the user numerical matches to the second birthday. The system outputs a statement of combined compatibility.

### Examples of Output User Information

This Section includes four examples that clarify the output data. Each example will include as the first input our example of the user with the May 31, 1961 birthdate. He or she would receive the following information: their birth card: the ace of clubs, their planetary ruling card: the queen of clubs, their zodiac sign: Gemini. The output compatible cards array would contain the following cards: firstly the birth card's diagonal elements including: the king of spades, the king of clubs and the four of clubs. The karma birth card elements are: the five of clubs, the king of spades and the eight of spades. The planetary ruling card's diagonal elements are: the king of hearts, the two of spades, the jack of diamonds, the nine of hearts, the two of diamonds. The karma planetary ruling card's diagonal elements include: the six of clubs, the two of clubs, the nine of spades, the king of clubs, the jack of clubs and the seven of diamonds. Since their birth card is a semi-fixed card we include the jack of hearts, the eight of clubs and the two of hearts. We also include the planetary ruling card's karma cards: the three of hearts and the ten of diamonds. In addition, the output of our example will include the life path compatibility number of eight that will be compatible with the following life path compatibility numbers: two, four, six and eight.

The first example will be an extremely compatible match in a Venus (friendship or love) connection. The second birthdate is Jan. 25, 1971. Their birth card is the two of diamonds and their planetary ruling card is the ten of diamonds. In addition, their zodiac sign is Aquarius. The compatible cards array contains the birth card diagonal elements: the queen of hearts, the ace of spades, the queen of clubs, the five of diamonds and the three of clubs. The karma birth card's diagonal elements are: the seven of hearts, the nine of diamonds, the five of diamonds, the three of hearts, the nine of clubs and the two of clubs. The planetary ruling card diagonal elements include: the jack of clubs, the nine of spades, the king of clubs and the seven of diamonds. The karma planetary ruling card's diagonal elements are: the king of hearts, the two of spades, the jack of diamonds, the nine of hearts, and the ten of hearts. We also include the birth card's karma cards: the ace of diamonds and the six of clubs. Additionally, we include the planetary ruling card's karma cards, the queen of spades and the queen of clubs. We note the five of diamonds is present in both the birth card diagonal elements and the karma birth card diagonal elements giving the second birthdate an identifying rare and powerful diagonal match connection. The first birthdate's planetary ruling card's diagonal element matches the second birthdate's birth card's diagonal element: the queen of clubs and the two of diamonds. The second birthdate's life path compatibility number is eight. This is an exact match to the first birthdate's life path compatibility number. These three matches indicate a very strong likelihood of compatibility; a natural fit, if you will.

The second example represents another extremely compatible match in a Jupiter (business) connection. The first birthdate, May 31, 1961, now has a much smaller compatible cards array. The first birthdate's birth card is the ace of clubs. The birth card's diagonal elements are: the queen of diamonds and the seven of clubs. The karma birth card's diagonal elements are: the eight of diamonds, and the nine of diamonds. The first birthdate's planetary ring card is the queen of clubs. The planetary ruling card's diagonal element is the five of diamonds. The karma planetary ruling card's diagonal element is the nine of diamonds. The second birthdate, Feb. 17, 1963 has a birth card of the eight of diamonds and a planetary ruling card of the five of clubs. Their compatible cards array includes: the Birth Card's diagonal element, the two of hearts. The karma birth card's diagonal element is the ace of clubs. The planetary ruling card's diagonal element is the queen of diamonds. The karma planetary ruling card's diagonal element is the three of diamonds. The first birthdate's Birth Card, the ace of clubs, has a match in the second birthdate's compatible cards array which is their karma birth card's diagonal element, the eight of diamonds. The second birthdate's life path compatibility number will be two. In addition, the first birthday's life path compatibility number, eight has a strong match (in the same row of the Pythagorean matrix) as the second birthdate, 2. These matches indicate a very strong likelihood of a compatible business relationship requiring minimal compromising while providing successful financial opportunities.

The third example represents a marginally compatible match in a Venus connection. The second birthdate, December 29, 1981, has a birth card of the two of hearts and a planetary ruling card of the two of diamonds. Their compatible cards array includes the birth card's diagonal elements: the five of clubs, the king of spades and the eight of spades. The karma birth card's diagonal elements are: the king of spades, the king of clubs and the four of clubs. The planetary ruling card's diagonal elements are: the queen of hearts, the ace of spades, the five of diamonds, the three of clubs, and the queen of clubs. The karma planetary ruling card's diagonal elements are: the seven of hearts, the nine of diamonds, the five of diamonds, the three of hearts, the nine of clubs and the two of clubs. We also include the birth card's karma card the ace of clubs and the planetary ruling card's karma cards: the six of clubs and the ace of diamonds. Since their birth card is a semi-fixed card we also include the eight of clubs, the nine of hearts and the seven of diamonds. There is also a diagonal match with the first birthdate's planetary ruling card, the queen of clubs and the second birthdate's planetary ruling card the two of diamonds. Additionally, there is a match between the semi-fixed cards: the ace of clubs and the two of hearts. The second birthdate's life path compatibility number is six. The life path compatibility number of the first birthdate, eight is usually compatible with the second birthdate's six. The match occurs in the life path compatibility array's, row eight: [x,6,x] (x's are ignored).

The fourth example represents a match rejection for both the Jupiter and Venus connections. Our example will only include the Venus connection. The second birthdate, Nov. 28, 1989, has a birth card of the five of hearts and a planetary ruling card of the seven of clubs. The second birthdate's compatible cards array includes: The birth card diagonal elements are: the eight of clubs, the four of clubs and the eight of hearts. The karma birth card diagonal elements are: the five of clubs, the seven of spades, the eight of clubs and the six of hearts. The planetary ruling card's diagonal elements are: the four of hearts, the six of diamonds, the four of clubs and the eight of hearts. The karma planetary ruling card's diagonal elements are: the five of clubs, the seven of spades, the ten of spades and the three of spades. We also include the birth card's karma cards: the five of clubs and the four of diamonds, as well as the planetary ruling card's karma cards: the eight of diamonds and the jack of spades. However there are no matches of the first birthdate's birth card (ace of clubs) or their planetary ruling card (queen of clubs) in the second birthdate's compatible cards array and vice versa. There are no matches of the second birthdate's birth card and planetary ruling card in the first birthdate's compatible cards array. In addition, there is no match of the respective life path compatibility numbers (eight and three).This would indicate a challenge and will require a great deal of compromises of the two individuals.

The fifth example represents an extraordinary match in a Venus (friendship or love) connection. Our example will only include the Venus connection. The second birthdate, Jan. 1, 1986, has a birth card of the king of spades, which is a fixed card, (meaning the karma birth card and the birth card are the same.) and a planetary ruling card of the five of clubs. The second's birthdate's compatible cards array includes: The birth card diagonal elements: The two of hearts, the five of spades, the ace of clubs, and the ten of hearts. The karma birth card diagonal elements are the same as the birth card diagonal elements since this is a fixed birth card. The planetary ruling card's diagonal elements are: the eight of clubs, the six of hearts, the eight of diamonds, the jack of diamonds, and the nine of hearts. The karma planetary ruling card's diagonal elements are: the three of diamonds, the seven of clubs, the five of hearts, the ace of clubs, the eight of clubs, and the four of clubs. We also include the remaining fixed and semi-fixed cards: the jack of hearts, and the seven of diamonds because as mentioned above the birth card is a fixed card. Lastly we include the planetary ruling card's karma card: the five of hearts.(we note the four of clubs is also a karma planetary ruling card and is included above as a karma planetary ruling card diagonal element), There is a match in both birthdate's birth card diagonal elements (the ace of clubs and the king of spades) as well as the second birthdate's planetary ruling card diagonal elements matches the first birthdate's karma birth card diagonal elements.(the five of clubs and the two of hearts). The life path compatibility numbers are an exact match. The combination of the these multiple diagonal elements and the exact match of the life path compatibility number make this an extraordinary match, requiring very little compromise and a deep connection of friendship and love.

Social media matches: The system supports an optional social media matching system where users complete a personal profile page that includes personal data such as: a photo, their name, birthday, height, weight, sex and email address plus a comment that best describes themselves (for example: their likes and/or dislikes, hobbies, sports, interests, and the like). In addition, the user can enter search filters, such as: height preference, sexual preference, national preference, regional preference, age range preference as well as other preferences to limit their search criteria.

Using the search filters, the system finds a compatible partner. The system displays a matrix of information regarding the compatible partner. For example, the system displays one or more regarding the compatible partner: a name, an age, a photograph, and a connection to the user.

The system receives from the user a selection of a compatible partner. The system sends to the user compatible partner information regarding the compatible partner. For example, the compatible partner information comprises one or more of a personal profile of the compatible partner, one or more compatible partners of the compatible partner, and an LPCN of the compatible partner.

The system sends a match message to the selected compatible partner. For example, the match message comprises the profile of the user. The system allows the compatible partner to perform one or more of accepting the user and rejecting the user. The system can receive from the user an instruction to enable communication with the selected compatible partner. For example, the communication comprises a conference. For example, the communication comprises a video conference. For example, the video conference comprises a live video chat. For example, the system offers the user an option to instruct the system to arrange a conference with a professional. For example, the professional comprises one or more of a relationship guide, an astrologer, and another professional. For example, the professional provides further insight.

Advantages of the invention include providing the user the opportunity in seeking a romantic connection using the invention's built-in intimacy components and focused compatibility analysis provided by its use of birthdates of the individuals to be matched.

Further advantages of the invention include its potential to provide a focused speed-dating capability able to provide users with a completely new approach for discovering one or more of a friendship, a romantic connection, and a, business connection.

For example, it will be understood by those skilled in the art that software used by the system and method for finding a compatible partner for a user may be located in any location in which it may be accessed by the system. It will be further understood by those of skill in the art that the number of variations of the network, location of the software, and the like are virtually limitless. It is intended, therefore, that the subject matter in the above description shall be interpreted as illustrative and shall not be interpreted in a limiting sense.

For example, embodiments of the invention could operate on a wide range of devices other than mobile phones, tablets, and computers without substantially affecting the functioning of embodiments of the invention.

While the above representative embodiments have been described with certain components in exemplary configurations, it will be understood by one of ordinary skill in the art that other representative embodiments can be implemented using different configurations and/or different components. For example, it will be understood by one of ordinary skill in the art that the order of certain steps and certain components can be altered without substantially impairing the functioning of the invention.

The representative embodiments and disclosed subject matter, which have been described in detail herein, have been presented by way of example and illustration and not by way of limitation. It will be understood by those skilled in the art that various changes may be made in the form and details of the described embodiments resulting in equivalent embodiments that remain within the scope of the invention. It is intended, therefore, that the subject matter in the above description shall be interpreted as illustrative and shall not be interpreted in a limiting sense.

What is claimed is:

1. A computer-based method for finding a compatible partner for a user by computing compatible diagonal elements for the user's birth card, comprising:
using one or more of a divination card system, a user's birthday and a standard deck of fifty-two playing cards, determining, by a computer-based system, one or more of a birth card (BC) of the user and a planetary ruling card (PRC) of the user;
if a desired connection is one or more of a friendship connection and a romantic connection, representing the user's birth card as M_{i,j}, where i and j are indices of one or more of a spiritual spread of the user and a life spread of the user: 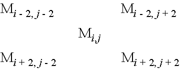
where M_{i,j} represents one or more of the user's BC and the user's PRC, and where M_{i-2,j-2},M_{i-2,j+2}, M_{i+2,j-2}, and M_{i+2,j+2} are diagonal elements that represent a successful reciprocal friendship/romantic relationship of the user's birth card;
representing with blank cards birth cards near one or more of a corner and an edge of a spread that have diagonal element indices that fall outside the spread;
removing the blank cards;
using remaining elements, computing remaining compatible diagonal elements; and
adding the compatible diagonal elements to the compatible cards array, so as to compute compatible diagonal elements for one or more of the user's BC and the user's PRC.

2. A computer-based method for finding a compatible partner for a user by computing compatible diagonal elements for the user's birth card, comprising:
using one or more of a divination card system, a user's birthday and a standard deck of fifty-two playing cards, and using a computer-based system, determining, by a computer-based system, one or more of a birth card (BC) of the user and a planetary ruling card (PRC) of the user;
if a desired connection is a business connection, representing the user's birth card as M_{i,j}, where i and j are indices of one or more of a spiritual spread of the user and a life spread of the user: 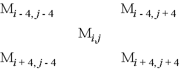
where M_{i,j} represents one or more of the user's BC and the user's PRC, and where M_{i-4,j-4},M_{i+4,j-4}, and M_{i+4,j+4} are diagonal elements that represent a successful reciprocal business relationship of the user's birth card;
representing with blank cards birth cards near one or more of a corner and an edge of a spread that have diagonal element indices that fall outside the spread;
removing the blank cards;
using remaining elements, computing remaining compatible diagonal elements; and
adding the compatible diagonal elements to the compatible cards array, so as to compute compatible diagonal elements for one or more of the user's BC and the user's PRC.

3. A computer-based method for finding a compatible partner for a user, comprising:
using a computer-based system, receiving the user's birthday from the user;
computing a day of the year of the user's birthday;
using the user's birthday, and using one or more of a divination card system, a user's birthday and a standard deck of fifty-two playing cards, determining one or more of the user's birth card (BC) and the user's planetary ruling card (PRC);
using the user's BC and the user's PRC, producing a compatible cards array comprising one or more partner cards that are likely to correspond to a compatible partner for the user;
computing compatible diagonal elements for the user's BC;
computing a life path compatibility number (LPCN) for the user;
computing an LPCN for the partner;
comparing the partner list of the user with partner lists of the partner;
comparing the LPCN of the user with the LPCN of the partner;
using the results of the comparing step, adding to the user's compatible cards array; and
outputting user information to the user.

4. The method of claim 3, further comprising:
receiving from the user a birthday of the partner.

5. The method of claim 4, further comprising:
computing a compatible cards array for the partner.

6. The method of claim 5, further comprising:
using the partner's birthday, computing a BC for the partner, computing a PRC for the partner, and computing an LPCN for the partner.

7. The method of claim 6, further comprising:
using the one or more of the BC, the PRC, and the LPCN for the user, and using the one or more of the BC, the PRC, and the LPCN for the partner, finding one or more of a match and a non-match between the user and the partner.

8. The method of claim 3, further comprising:
generating a karma card for the user.

9. The method of claim 8, wherein the karma card comprises one or more of a karma spiritual birth card, a karma life card, and a karma life PRC, and a karma spiritual PRC.

10. The method of claim 9, wherein the system generates the user's karma spiritual birth card by indexing into the spiritual spread using a life card number of the user.

11. The method of claim 9, wherein the system generates the user's karma life card by indexing into the life spread using the user's BC number.

12. The method of claim 9, wherein the system generates the user's karma life PR card by indexing into the spiritual spread using a life PRC number of the user.

13. The method of claim 9, wherein the system generates the user's karma spiritual PR card by indexing into the life spread using a spiritual PRC number of the user.

14. The method of claim 8, further comprising:
appending one or more of the karma cards to the compatible cards array.

15. The method of claim 6, further comprising:
comparing the compatible cards array for the user with the compatible cards array for the partner.

16. The method of claim 15, further comprising a step, performed after the comparing step, of:
determining if a match exists between the user's BC and the partner's BC.

17. The method of claim 15, further comprising a step, performed after the comparing step, of:
determining if a match exists between the user's PRC and the partner's PRC.

18. The method of claim 16, comprising:
for any matching BCs, generating a matched data message to the user.

19. The method of claim 3, further comprising:
computing compatibility of the user and the partner.

20. The method of claim 3, wherein the user information comprises one or more of the user's BC, the user's PRC, the user's LPCN, a zodiac sign of the user, the user's compatible cards array, a statement of combined compatibility, numerical matches to the partner's birthday, the partner's BC, the partner's PRC, a zodiac sign of the partner, the partner's LPCN, the partner's compatible cards array, a matrix of information regarding the partner, the partner's name, the partner's gender, the partner's age, the partner's height, the partner's geographic location, the partner's sexual orientation, the partner's race, a photograph of the partner, an audio file of the partner, a video file of the partner, a connection of the partner to the user, a personal profile of the partner, one or more compatible partners of the partner, a karma card of the partner, and a contact means for the user to contact the partner.
